(19) United States
(12) Patent Application Publication
(10) Pub. No.: US 2013/0163773 A1
(43) Pub. Date: Jun. 27, 2013

(54) CLOSED-LOOP ACTIVE NOISE REDUCTION SYSTEM, SUCH AS FOR A THERMAL PRINTER

(71) Applicant: Intermec IP Corp., Everett, WA (US)

(72) Inventors: Zhiyong Liu, Singapore (SG); Ter Liang Tong, Singapore (SG)

(73) Assignee: INTERMEC IP CORP., Everett, WA (US)

(21) Appl. No.: 13/725,257

(22) Filed: Dec. 21, 2012

Related U.S. Application Data
(60) Provisional application No. 61/579,963, filed on Dec. 23, 2011.

(51) Int. Cl. G10K 11/16

(52) U.S. Cl. 381/71.3

(57) ABSTRACT

A system and method for reduce noise emitted by a printer are disclosed herein. In one embodiment, a sound detector disposed proximate to a noise source detects a measured noise signal, which is analyzed to determine one or more resonant frequencies thereof. A feedback signal is determined based on the analyzed noise signal and is used to generate a compensated signal 180 degrees out of phase with the feedback signal. The compensated signal is output proximate to the noise source.

### CROSS-REFERENCE TO RELATED APPLICATION(S)

This application claims priority to U.S. Provisional Patent Application No. 61/579,963, filed Dec. 23, 2011 and entitled “CLOSED-LOOP ACTIVE NOISE REDUCTION SYSTEM, SUCH AS FOR A THERMAL PRINTER”, which is incorporated herein in its entirety by reference.

### BACKGROUND

The present invention generally relates to active noise control of thermal printers and other devices.

The primary noise source during the operation of a thermal printer is the sticking of the thermal print head to thermal print media passing through the thermal printer. As the print head heats the print media, the print media adheres to the print head and when the print media is moved by a motor in the printer, this adhesion is broken. This adhesion-breaking event results in the generation of noise, and successive adhesion-breaking events can cause a significant amount of noise. The noise generated during these events is proportional to the speed at which the thermal media is moving through the printer. These adhesion-breaking events can also excite resonances in the printer cabinet, resulting in even more noise generated during operation of the thermal printer. Conventional noise control systems employed in thermal printers focus on reducing the overall noise signal generated by the thermal print head, and typically ignore the component causing the printer cabinet resonance.

In addition, many conventional active noise control systems utilized in thermal printers focus on the cancellation of the overall noise signal generated during printer operation. Cancellation of a noise signal involves inverting a source signal 180 degrees out of phase from the source signal and emitting the inverted signal. The overall noise signal is typically a very complex waveform and, thus, a cancellation waveform can be very difficult to generate, particularly in three dimensions.

Moreover, conventional active noise reduction systems utilize an open-loop system. Open-loop active noise reduction systems include a microphone disposed near a sound source, an inversion circuit that outputs a signal 180 degrees out of phase from the source signal, and an emitter that emits the cancellation signal. However, printers are very dynamic systems, sensitive to several factors, such as temperature, humidity, position shift, and loading pressure. Changes to these conditions or number of other variables can have a significant effect on the noise generated during printer operation. Open-loop active noise reduction systems may not sufficiently compensate for changes in the printer system.

Therefore, it would be advantageous to develop an active noise control system that overcomes the above problems, as well as providing other benefits. Overall, the above examples of some related systems and associated limitations are intended to be illustrative and not exclusive. Other limitations of existing or prior systems will become apparent to those of skill in the art upon reading the following detailed description.

### BRIEF DESCRIPTION OF THE DRAWINGS

FIG. 1A shows a prior art graphical representation of two waves of the same frequency but out of phase by 180 degrees and the resultant waveform.

FIG. 1B shows a graphical representation of the sound pressure level of a waveform generated during operation of a thermal printer.

FIG. 1C shows a representation of the phase of an inverted waveform generated to cancel a source waveform generated during operation of a thermal printer.

FIG. 2 is a diagram illustrating operation of a closed-loop feedback active noise reduction system, configured in accordance with one embodiment of the disclosure.

FIG. 3 is a flow diagram of a routine for attenuating printer noise using a closed-loop feedback system under one implementation of the disclosure.

FIG. 4 is a block diagram of an active noise reduction system 400 for a thermal printer under one example of an implementation of the disclosure.

### DETAILED DESCRIPTION

Various aspects of the disclosure will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

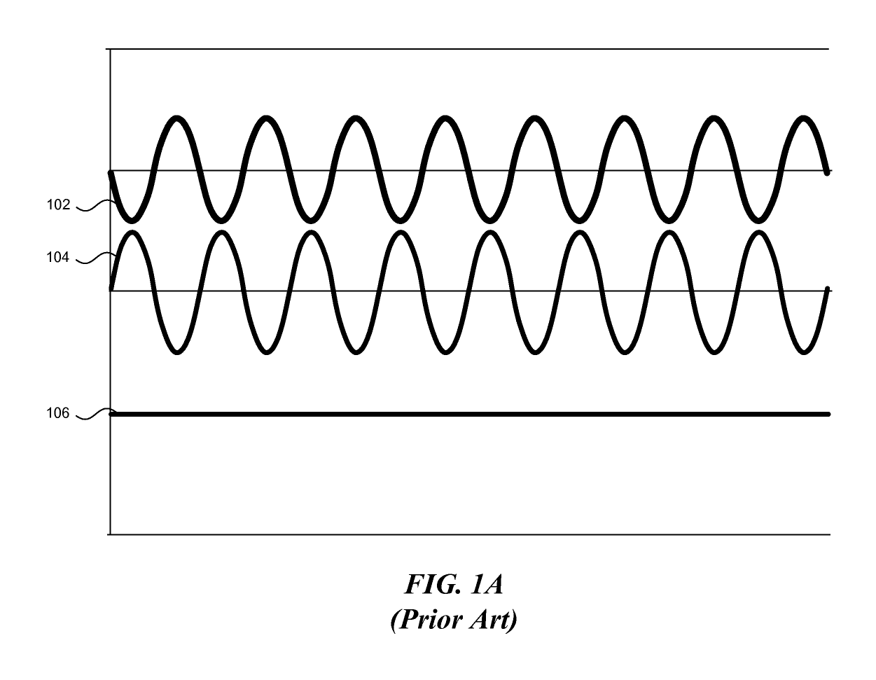

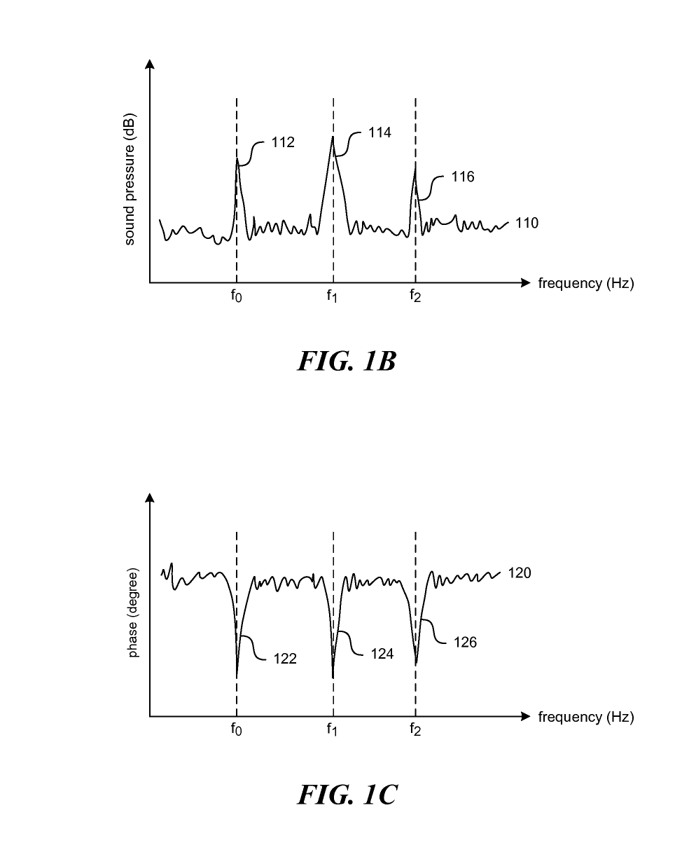

The system disclosed herein uses active noise reduction to attenuate a noise signal at select resonant frequencies f. Active noise reduction utilizes a property of waves known as constructive interference to cancel or significantly reduce the energy of one or more waves. FIG. 1A displays this in more detail. FIG. 1A includes a first waveform 102, a second waveform 104, and a third waveform 106. The first waveform 102 and the second waveform 104 have the same frequency, but are 180 degrees out of phase with each other. That is, the troughs, or minimum amplitudes, of the first waveform 102 correspond to the peaks, or maximum amplitudes, of the second waveform 104 and vice versa. If the waveforms 102 and 104 are emitted simultaneously, the waveforms 102 and 104 can constructively interfere with each other, effectively cancelling each other if the amplitudes of the waveforms 102 and 104 are identical. When waveform 102 and waveform 104 are combined, the troughs of waveform 102 and the corresponding peaks of waveform 104 negate each other. In the same way, the peaks of waveform 102 and the corresponding troughs of waveform 104 also negate each other. The null waveform 106 is the result of the combination of the two waveforms 102 and 104. As described in further detail below, this concept of constructive interference of waves can be used to attenuate the noise emitted by a thermal printer.

The graph of FIG. 1B shows a typical plot of the frequency content of a noise signal 102 measured proximate to a thermal printer during operation. The plot is a frequency domain representation of the noise signal 110 with frequency (measured in Hertz (Hz)) along the x-axis and sound pressure level (measured in decibels (db)) along the y-axis. The noise signal 110 includes several peaks 112, 114 and 116. The peaks 112, 114 and 116 correspond to the maximum amplitudes of the signal 110 and occur at resonance frequencies f₀, f₁ and f₂, respectively, of the printer during operation. (While f f₀, f₁ and f₂ are shown, different printers could have more or fewer resonant frequencies with different amplitudes). The resonance frequencies are those frequencies at which a system tends to vibrate at much larger amplitudes compared to other frequencies. A resonance frequency generally occurs in a system when the corresponding wavelength of a sound source is proportional to the length of at least one of the dimensions of the system. For example, the resonance frequencies of a rectangular box (analogous to a thermal printer) are given by the following formula:

$$f = \frac{c}{2} \sqrt{{( \frac{l}{{L}_{x}} )}^{2} + {( \frac{m}{{L}_{y}} )}^{2} + {( \frac{n}{{L}_{z}} )}^{2}}$$

where f is the resonance frequency, c is the speed of sound; Lₓ, L_{y}, and L_{z} are the x, y and z dimensions of the box, and l, m, and n are positive integers.

During operation of the thermal printer, the interaction of the thermal print head with the thermal media can transmit mechanical energy into the printer body. This transmission can lead to the excitation of one or more resonant frequencies of the printer body, also known as resonance modes. Excitation of the resonance modes can result in the emission of a disproportionately large amount of acoustic energy in response to small amount of input energy. Indeed, the sound pressure levels of the noise signal 102 emitted by the thermal printer at the resonance frequencies f₀, f₁ and f₂ are significantly higher than at non-resonant frequencies. Thus, reducing the noise signal 110 at the resonance frequencies f can lead to a significant attenuation of the overall noise level.

The graph of FIG. 1C shows a typical plot of the phase of a noise signal 120 measured proximate to a thermal printer during operation. The plot is a frequency domain representation of the phase of the noise signal 120 with frequency (measured in Hertz (Hz)) along the x-axis and phase (measured in degrees) along the y-axis. The noise signal 120 has troughs 122, 124 and 126 that corresponded to the resonant frequencies f₀, f₁ and f₂, respectively. Reducing or cancelling the acoustic energy at these frequencies can be achieved by emitting a waveform having similar amplitude while being 180 degrees out of phase from the original waveform. Thus, determining the phase of the resonance frequencies of the original waveform is also important in the cancellation process.

### Suitable System

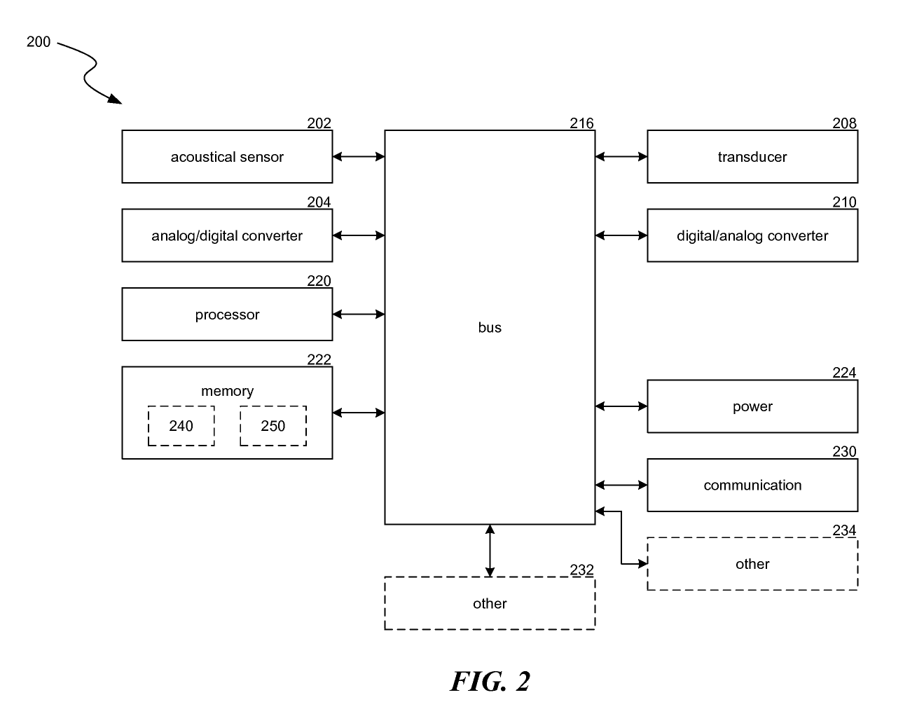

FIG. 2 and the following discussion provide a brief, general description of a suitable environment in which the technology may be implemented. Although not required, aspects of the technology are described in the general context of computer-executable instructions, such as routines executed by a general-purpose computer (e.g., a printer, scanner, and/or imager). Aspects of the technology can be embodied in a special purpose computer or data processor that is specifically programmed, configured, or constructed to perform one or more of the computer-executable instructions explained in detail herein. Aspects of the technology can also be practiced in distributed computing environments where tasks or modules are performed by remote processing devices, which are linked through a communication network. In a distributed computing environment, program modules may be located in both local and remote memory storage devices.

Aspects of the technology may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the technology may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme).

Referring to FIG. 2, a block diagram illustrating example components of a active noise reduction system 200 is shown. The system 200 may include an acoustical sensor 202, such as a microphone or piezoelectric transducer. The sensor 202 may measure the noise emitted by a noise source, such as a printer and/or another device (e.g. a scanner, copier, fax machine, etc.). Indeed, the system 200 may be incorporated into such components as within a thermal printer. An analog-to-digital converter 204 can convert noise waveforms received by noise sensor 202 to digital signals that the system 200 may analyze and process. A digital-to-analog converter 210 can convert processed signals to analog waveforms that the transducer 208 outputs.

The system 200 may control components and/or the flow or processing of information or data between components using one or more processors 220 in communication with the memory 222, such as ROM or RAM (and instructions or data contained therein) and the other components via a bus 216. The memory 222 may contain data structures or other files or applications that provide information related to the active noise control of a measured noise signal. For example, the memory 222 may contain one or more subroutines 240 that perform frequency domain transforms (e.g. Fourier transforms) as noted herein. The memory may also, for example, contain one or more analyzing subroutines 250 that can be used, for example, to analyze a digital signal to find one or more peaks in the signal. In addition, in some implementations, instructions stored in the memory 222 may perform analog-to-digital conversion and digital-to-analog conversion.

Components of the system 200 may receive energy via a power component 224. Additionally, the system 200 may receive or transmit information or data to other modules, remote computing devices, and so on via a communication component 230. The communication component 230 may be any wired or wireless components capable of communicating data to and from the system 200. Examples include a wireless radio frequency transmitter, infrared transmitter, or hard-wired cable, such as a USB cable. The communication component 230 may allow the system 200 to communicate with an external system (e.g., one or more other printers) to send and receive information. The information may include, for example, measured noise levels at a location external to the system 200, noise levels received by the system 200, and/or noise levels emitted by the transducer 208.

The system 200 may include other additional components 232, 234 not explicitly described herein, such as communication components, printer components, one or more printer control systems, additional microprocessor components, removable memory components (flash memory components, smart cards, hard drives), and/or other components. In some implementations, for example, the processor 220 may be configured to communicate with a printer control system (e.g., via component 232 ) to slow or change operations in response with a noise level detected by the sensor 202. For example, the processors 220, upon detecting a predetermined threshold noise level, can be configured to provide instructions to a thermal print head to operate at a lower speed and/or in a reduced power mode to attenuate the noise levels produced therefrom.

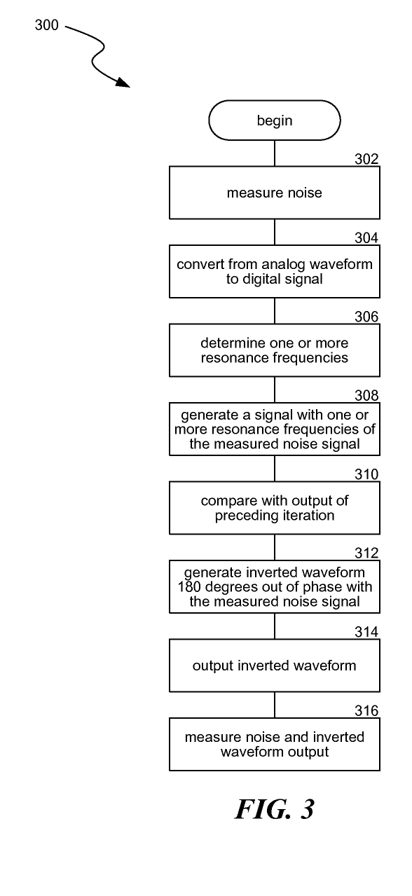

FIG. 3 is a flow diagram of a routine 300 for attenuating noise using a closed-loop feedback system under one implementation of the disclosure. Routine 300 may reside, for example, in memory 222, and run in processor 220. In block 302, the system measures acoustic noise produced by a noise source, for example, a printer. The noise may be measured by a sensor, such as an electromechanical, piezoelectric, and/or another suitable transducer configured to measure acoustic waves. In some embodiments, for example, the sensor can be configured to receive and/or measure acoustic energy in one or more octave bands (e.g. 63 Hz, 125 Hz, 250 Hz. 500 Hz. 1000 Hz., 2000 Hz, etc.) or the entire range of human hearing (20 Hz-20,000 Hz). In other embodiments, the sensor can be configured to receive acoustic energy of any frequency range of interest (e.g., ultrasound).

The sensor choice may be determined by the frequency content of the likely noise source. In some devices, such as thermal printers, a substantial amount of noise is produced by an interaction of a thermal print head and a thermal print medium. As the thermal print head heats the print media, the print medium may adhere to the print head and when the print medium is moved by a motor through the printer, the adhesion is broken. One or more adhesion-breaking events may result in the generation of high frequency noise. Therefore, a sensor with greater sensitivity to higher frequencies response may be selected. In other printers, fans and/or motors, for example, in the printers may be primary acoustic noise source. Fans and motors may have lower frequency content than the adhesion-breaking events discussed above and, accordingly, a sensor sensitive to those lower frequencies may be selected.

For a given device model, the acoustical qualities of the printer can be measured and noise sources identified to determine suitable placement of one or more sensors in the printer body. For a thermal printer, at least one sensor can be located near the thermal print head. However, one or more additional sensors may be deployed in the printer body to measure other noise sources (e.g. fans, motors, paper feeders, etc.) within the printer. In some embodiments, for example, the routine 300 can be configured to receive noise levels and/or other information (e.g., via the communication component 230) pertaining to external noise sources. The routine 300 can use this information, for example, to compensate for noise impacts caused by noise sources external to the printer.

In block 304, the routine 300 converts the analog measured noise waveform from block 302 to a discrete time digital measured noise signal. Block 304 may utilize any suitable analog-to-digital conversion method known in the art, such as delta-encoded analog to digital conversion, to create the discrete time digital signal. The analog to digital converter may be a separate hardware component or may reside in, for example, memory 222 and in processor 220.

In block 306, the routine 300 can obtain a frequency spectrum of the digital measured noise signal using a frequency domain transform (e.g. a Fourier transform, Fourier Series, and/or a Z-transform). The routine 300 can analyze the amplitude peaks and/or phase minima (as in, for example, FIGS. 1B and 1C) of the frequency spectrum to determine one or more resonance frequencies. In some implementations of the routine 300, there may be only one resonance frequency identified, while in other implementations there may be two or more resonance frequencies.

In block 308, the routine 300 generates a digital time-domain signal having generally the same or similar amplitude, phase, and frequency characteristics as the resonance peaks identified in block 306. For example, if the routine 300 (in block 306) identifies the resonance peaks of the measured signal as occurring at frequencies of 250 Hz, 500 Hz, and 1000 Hz, with amplitudes of 40 dB, 35 dB, and 30 dB, respectively, the routine 300 can (in block 308) generate a signal that is a superposition of three waves having those characteristics all in phase with each other.

In block 310, the routine 300 generates an inverted signal by inverting the signal generated in block 308 so that the inverted signal is 180 degrees out of phase with the signal in block 308. As described above, inverting the signal can cause destructive interference of a waveform having the same frequency and approximately 90 degrees to 270 degrees out of phase with the inverted signal. If the waveform has approximately the same frequency and amplitude is 180 degrees out of phase with inverted signal, total destructive interference can occur. See, for example, FIG. 1A, for a graphical representation.

In block 312, the routine 300 generates a compensated signal by comparing the output of the preceding iteration with the inverted signal. The routine 300 calculates the difference of the preceding output and the inverted signal, thereby generating a compensated signal. Comparing portions of the measured signal (i.e. the resonance peaks) with the preceding output allows the routine 300 to dynamically adjust to changes in the measured system and/or environment. For example, if the measured noise in block 302 is produced by a printer, the routine 300 can compensate for events such as the printer being powered on, the printer being powered off, changes in print head speed, etc.

The routine 300 in block 312 can also implement a phase shift into the compensated signal 300 to compensate for the distance between the detected noise source and one or more emitters. As those of ordinary skill in the art will appreciate, if the distance between a noise source and an emitter is not an integer multiple of the wavelength of the resonant frequency, a phase shift in the compensation signal can allow for more effective interference of the acoustic energy emanating from the noise source by more closely aligning the troughs of the compensated signal with corresponding peaks of the noise at one or more resonant frequencies.

The routine 300 in block 312 may also, for example, adjust the compensated signal to account for changes in the operating environment. Noise from the operation of a device, such as a printer, may be significantly more irritating to nearby observers in a room with a relatively low background noise level (e.g. less than 45 dBA) than in a room with a relatively high background noise level (e.g. greater than 45 dBA). For example, if the noise floor in a room increases and/or decreases due to the operation of HVAC equipment in the room, the routine 300 can respectively decrease or increase the amplitude of the compensated signal in block 312 accordingly.

In block 314, the routine 300 converts the digital compensated signal to an analog compensated waveform using a digital to analog converter. The analog compensated waveform is output by a transducer, such as an electromechanical transducer (e.g. a speaker) and/or a piezoelectric transducer. The routine 300 returns to block 302 where it may perform another iteration.

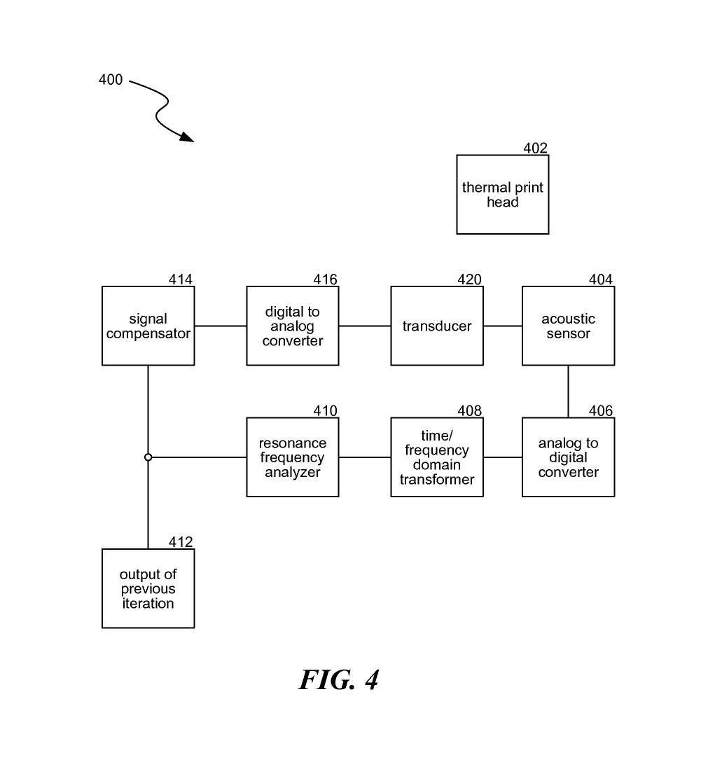

FIG. 4 shows one example of an implementation of an active noise reduction system 400 for a thermal printer. An activated thermal print head 402 prints onto thermal media (not shown). The interaction between the thermal print head 232 and the thermal media causes the emission of a noise waveform, which is detected by an input 404. The acoustic sensor 404 can be, for example, an electromechanical transducer (e.g. a microphone) and/or a piezoelectric tranducer.

An analog-to-digital converter 406 converts the noise waveform from an analog measurement to a digital measured signal. An analyzer 408 converts the measured signal from a standard time-domain signal to a frequency-domain signal. This time-to-frequency domain conversion can be performed using a suitable transfer function (e.g. a Fast Fourier Transform or FFT) and can allow for identification of one or more resonant frequencies f at which the thermal printer may be emitting noise. A signal generator 410 outputs a resonance frequency signal, containing the one or more resonance frequencies f of the measured noise signal. An inverter 411 generates an inverted signal that is 180 degrees out of phase with the resonance frequency signal. A compensator 414 calculates a difference between the inverted signal and a preceding output signal 412, and generates a compensated signal. A digital to analog converter 416 converts the compensated signal to an analog inverted waveform. An output 420 (e.g. a speaker, piezoelectric transducer, and/or other suitable transducer) outputs the inverted waveform.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the technology is not intended to be exhaustive or to limit the technology to the precise form disclosed above. While specific embodiments of, and examples for, the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the technology in light of the above Detailed Description. While the above description describes certain embodiments of the technology, and describes the best mode contemplated, no matter how detailed the above appears in text, the technology can be practiced in many ways. Details of the data collection and processing system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless the above Detailed Description section explicitly defines such terms. Accordingly, the actual scope of the technology encompasses not only the disclosed embodiments, but also all equivalent ways of practicing or implementing the technology under the claims.

While certain aspects of the technology are presented below in certain claim forms, the inventors contemplate the various aspects of the technology in any number of claim forms. For example, while only one aspect of the technology is recited as embodied in a computer-readable medium, other aspects may likewise be embodied in a computer-readable medium. Accordingly, the inventors reserve the right to add additional claims after filing the application to pursue such additional claim forms for other aspects of the technology.

I/We claim:

1. A method of reducing acoustic noise generated by a printer, the method comprising:
receiving a noise signal from a first sound detector disposed at least proximate to an acoustic noise source during operation of the printer;
analyzing the measured noise signal to determine one or more resonant frequencies of the measured noise signal;
generating a resonance frequency signal containing the one or more resonance frequencies of the measured noise signal;
determining a feedback signal, wherein the feedback signal is a difference between the resonance frequency signal and a preceding output signal of a closed feedback loop;
generating a compensated signal, wherein the compensated signal is approximately 180 degrees out of phase with the feedback signal; and
outputting the compensated signal to at least attenuate the noise signal.

2. The method of claim 1 wherein the first sound detector is a piezoelectric transducer.

3. The method of claim 1 wherein the compensated signal is output by an emitter disposed at least proximate to the noise source.

4. The method of claim 3 wherein the emitter is a piezoelectric transducer.

5. The method of claim 3, further comprising:
determining a distance between the acoustic noise source and the first emitter;
calculating a phase shift based on the distance and one or more wavelengths corresponding to the one or more resonant frequencies; and
applying the phase shift to the compensated signal if the distance is not approximately equal to an integer multiple of at least one of the one or more wavelengths.

6. The method of claim 1, further comprising receiving a second noise signal from at least a second sound detector disposed on the printer, wherein the method further comprises analyzing the second noise signal for one or more resonant frequencies.

7. The method of claim 1 wherein generating the compensated signal comprises increasing or decreasing an amplitude of the compensated signal based on a background noise level external to the printer.

8. The method of claim 1 wherein the outputting includes transmitting the compensated signal to a plurality of emitters disposed on the printer.

9. The method of claim 1 wherein the printer is a thermal printer.

10. The method of claim 1 wherein the acoustic noise source is a thermal print head.

11. The method of claim 1 wherein the analyzing includes performing a Fourier transform on the measured noise signal.

12. A tangible computer readable medium storing instructions, which when executed by at least one computing device, performs a method of reducing acoustic noise generated by a printer, the method comprising:
receiving a noise signal from a sound detector disposed at least proximate to an acoustic noise source during operation of the printer;
analyzing the measured noise signal to determine one or more resonant frequencies of the measured noise signal;
generating a resonance frequency signal containing the one or more resonance frequencies of the measured noise signal;
determining a feedback signal, wherein the feedback signal is a difference between the resonance frequency signal and a preceding output signal of a closed feedback loop;
generating a compensated signal, wherein the compensated signal is approximately 180 degrees out of phase with the feedback signal; and
outputting the compensated signal to an emitter disposed at least proximate to the noise source.

13. The method of claim 12 wherein the computing device is disposed in a thermal printer.

14. The method of claim 14 wherein the instructions further include instructions for—
determining a distance between the acoustic noise source and the emitter;
calculating a phase shift based on the distance and one or more wavelengths corresponding to the one or more resonant frequencies; and
applying the phase shift to the compensated signal if the distance is not approximately equal to an integer multiple of at least one of the one or more wavelengths.

15. An apparatus for reducing noise emitted from a thermal printer, comprising:
an acoustic sensor positioned proximate to a thermal print head, wherein the sensor is configured to receive acoustic energy emitted by the thermal print head and convert the energy to an electrical noise signal;
an analysis component configured to detect one or more resonant frequencies in the noise signal;
a signal generator configured to generate a resonant frequency signal comprising one or more of the detected resonant frequencies;
an inverting component configured to invert the resonant frequency signal by approximately 180 degrees;
a signal compensation component configured to compare the inverted signal with a previously output signal and produce a compensated signal; and
an output transducer configured to output the compensated signal, wherein the transducer is positioned proximate to the thermal print head and the sensor.

16. The apparatus of claim 15 wherein the sensor is a piezoelectric transducer.

17. The apparatus of claim 15 wherein the signal compensation component is further configured to—
determine a distance between the thermal print head and the output transducer;
calculate a phase shift based on the distance and one or more wavelengths corresponding to the one or more resonant frequencies; and
applying the phase shift to the compensated signal if the distance is not approximately equal to an integer multiple of at least one of the one or more wavelengths.
